(19) United States
(12) Patent Application Publication
(10) Pub. No.: US 2015/0375277 A1
(43) Pub. Date: Dec. 31, 2015

(54) VENDING CLEANING SYSTEM

(71) Applicant: Lessie Lee Hall, Memphis, TN (US)

(72) Inventor: Lessie Lee Hall, Memphis, TN (US)

(21) Appl. No.: 14/595,409

(22) Filed: Jan. 13, 2015

Related U.S. Application Data
(60) Provisional application No. 62/018,976, filed on Jun. 30, 2014.

(51) Int. Cl. B08B 9/08

(52) U.S. Cl. CPC B08B 9/08

(57) ABSTRACT

A cleaning system for a vending machine including: a fluid container, where the fluid container is installed on an interior surface of a door of the vending machine; a tubing system extending from the fluid container along the sides of the door; and a pump switch configured in line with the tubing system, where the pump enables the flow of the fluid through the tubing system. The tubing system may include a container tubing extending from the fluid container to the pump switch. The tubing system may also include a side tubing extending from the pump switch and said side tubing connects to a top tubing, where the fluid dispenses from the top tubing.

### CROSS REFERENCE TO OTHER APPLICATIONS

This application claims priority to U.S. Provisional Application Ser. No. 62/018,976 filed on Jun. 30, 2014.

### BACKGROUND OF THE INVENTION

1. Field of Invention

The present invention relates to a cleaning system that is implemented within a standard vending machine.

2. Description of Related Art

Vending machines are stand-alone machines that dispense various items such as snacks, beverages, cigarettes or other small consumer products. Vending machines may be placed in various locations to attract customers. The typical vending machine is a large cube-shaped container that usually includes a front opening door, where the opening door includes a clear display surface. The display surface allows the customer to view the items within the vending machine that are for sale. This clear panel needs to remain clean and clear in order to attract customers and further to allow for the customers to view the items within the vending machine. Currently there are not any particular solutions to address the cleaning process. Many times vending machine operators simply spray the display down with a hand spray and a paper towel. One drawback to this method is the vending operator must carry cleaning solution to clean the front display panel. It would therefore be advantageous to have a system installed that at least alleviates the necessity for the vending operator to transport cleaning solution along with other items while servicing a vending machine.

### SUMMARY OF THE INVENTION

The present invention relates to a cleaning system for a vending machine comprising: a fluid container, where the fluid container is installed on an interior surface of a door of the vending machine; a tubing system extending from the fluid container along the sides of the door; and a pump switch configured in line with the tubing system, where the pump enables the flow of the fluid through the tubing system. The tubing system may include a container tubing extending from the fluid container to the pump switch. The tubing system may also include a side tubing extending from the pump switch and said side tubing connects to a top tubing, where the fluid dispenses from the top tubing.

### BRIEF DESCRIPTION OF DRAWINGS

FIG. 1 depicts a vending machine with a vending cleaning system installed in accordance with the present invention.

### DETAILED DESCRIPTION

The present invention relates to a vending cleaning system that may be installed within a conventional vending machine. The vending cleaning system enables the application and release of cleaning solution over a clear panel on the door of the vending machine. The vending cleaning system includes a cleaning fluid container that stores cleaning fluid. This cleaning fluid is dispensed through tubing system that runs along one side of the door panel. The tubing system extends to the topside of the display panel and allows for the dispensing of fluid over the panel surface.

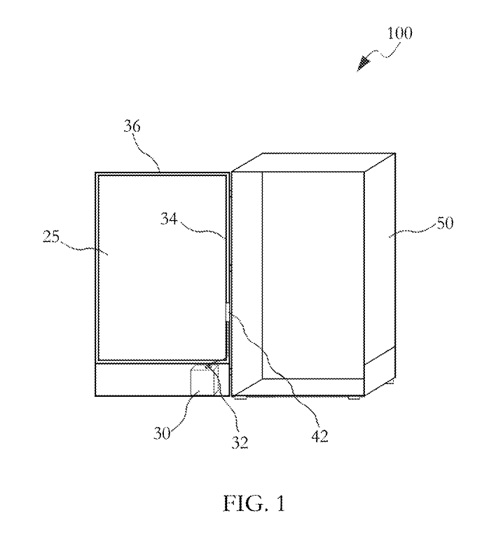

With respect to FIG. 1, a vending machine 100 is depicted. In particular the vending machine 100 includes a body portion 50. The body portion 50 stores any items that are for sale through the vending machine 100. As with most vending machines, a door 25 is provided that is locked and opened to allow a vending operator to access the interior of the body portion 50. The door 25 includes a clear surface that enables customers to view the items within the vending machine. On the inside lower panel of the door 25, a fluid container 30 is installed. The fluid container 30 stores cleaning fluid that is dispensed through a tubing system that runs along the side of the door 25. A container tubing 32 extends out from the top of the container 30 and leads to a switch/pump 42. The switch/pump 42 pumps the fluid through the tubing 32 extending from the fluid container 30 and outward to a side tubing 34 and forward to a top tubing 36.

Alternatively, the switch/pump 42 may also be installed on the key panel of the vending machine. The top tubing 36 has openings that allow for the dispensing of fluid onto the clear panel of the door 25. As this fluid is dispensed a user merely needs to wipe the cleaning solution and clean the clear surface of the vending door 25. The fluid may be dispensed onto either the outside or inside surface, or both, of the clear panel of the door 25.

The present vending cleaning system provides convenient means to clean and maintain a vending machine. Further the ability to store the fluid within the vending machine eliminates the necessity for a vending operator to transport cleaning solution while maintaining the vending machine. The instant invention has been shown and described in what it considers to be the most practical and preferred embodiments. It is recognized, however, that departures may be made there from within the scope of the invention and that obvious modifications will occur to a person skilled in the art.

What is claimed is:

1. A cleaning system for a vending machine comprising:
a. a fluid container, where the fluid container is installed on an interior surface of a door of the vending machine;
b. a tubing system extending from the fluid container along the sides of the door; and
c. a pump switch configured in line with the tubing system, where the pump enables the flow of the fluid through the tubing system.

2. The cleaning system according to claim 1, where the tubing system includes a container tubing extending from the fluid container to the pump switch.

3. The cleaning system according to claim 2, where the tubing system includes a side tubing extending from the pump switch and said side tubing connects to a top tubing.

4. The cleaning system according to claim 3, where fluid dispenses from the top tubing.
